(19) United States
(12) Patent Application Publication
(10) Pub. No.: US 2010/0088825 A1
(43) Pub. Date: Apr. 15, 2010

(54) Fluidizable Bed with Supportive Filter Sheet

(76) Inventors: Charles A. Howell, Batesville, IN (US); Charles A. Lachenbruch, Lakeway, TX (US)

Correspondence Address: HILL-ROM SERVICES, INC., Legal Dept., Mail Code K04, 1069 State Road 46 East, BATESVILLE, IN, 47006, US

(21) Appl. No.: 12/549,867

(22) Filed: Aug. 28, 2009

Related U.S. Application Data
(60) Provisional application No. 61/103,963, filed on Oct. 9, 2008.

(51) Int. Cl. A61G 7/057; A47C 27/08

(52) U.S. Cl. 5/689

(57) ABSTRACT

One variant of a fluidizable bed 10 includes a fluidizable material 36 within a containment vessel 12 and a filter sheet 24 having a vent region 42 covering a top portion 22 of the vessel. The vent region has a permeability of less than about 65 cubic feet per minute per square foot. Other variants of a fluidizable bed 10 include a fluidizable material 36 within a containment vessel 12, a filter sheet 24 connected to the vessel, and a vent region 42 of the filter sheet covering a top portion of the vessel and having a permeability sufficient to 1) establish a pressure difference across the filter sheet equal to or greater than a prescribed pressure difference threshold, or 2) support no more than a specified, non-negligible portion of an occupant's weight. Also disclosed is a fluidizable patient support system capable of supporting an occupant weighing more than about 300 pounds and preferably more than about 400 pounds while maintaining the fluidizable material in a fluidized state and 2) a fluidized bed weighing no more than about 950 pounds and 3) a fluidizable bed weighing no more than about four times the weight of an occupant thereof. Also disclosed is a fluidizable bed in which a filter sheet assumes a taut state to support some of the weight of bed occupant. Also disclosed is a retrofit kit for retrofitting pre-existing beds to take advantage of the concepts disclosed herein.

### CROSS REFERENCE TO RELATED APPLICATIONS

This application claims priority to U.S. Provisional Application No. 61/103,963 entitled “Fluidizable Bed with Supportive Filter Sheet” filed on Oct. 9, 2008, the contents of which are expressly incorporated by reference herein.

### TECHNICAL FIELD

This application describes subject matter relating to fluidizable beds and particularly fluidizable beds in which a filter sheet supports a non-negligible portion of an occupant's weight.

### BACKGROUND

Health care professionals may recommend the use of fluidizable beds for patients who suffer from skin disorders or who would be at significant risk of developing skin disorders as a result of occupying a non-fluidizable bed. A typical fluidizable bed includes an impermeable containment vessel containing a fluidizable particulate material. A liner is secured to the containment vessel. A filter sheet is joined to the liner at a seam. The seam is tight enough to resist migration of the beads through the seam and ideally is also substantially fluid-tight. A gas permeable vent region of the filter sheet extends across the top of the containment vessel. The vent region has pores that are small enough to resist migration of the beads through the filter sheet. At least the vent region of the filter sheet is in a slack or relaxed state.

The fluidizable bed also includes an air distribution chamber connected to a source of pressurized air. A porous diffuser partition acts as the upper surface of the air distribution chamber and the lower surface of the containment vessel.

During operation, pressurized air enters the air distribution chamber, flows through the diffuser partition and the fluidizable material, and exhausts through the filter sheet. The velocity of the air flowing through the material “fluidizes” the material so that the material and air, taken together, exhibit fluid-like properties. As a result, the occupant of the bed is supported on a quasi-fluid having a specific gravity greater than that of the occupant; the filter sheet remains slack and supports essentially none of the occupant's weight. Such a system of support is beneficial for occupants suffering from skin disorders or at significant risk of developing skin disorders.

One drawback of fluidizable beds is the weight of the fluidizable material. Fluidizable beds typically weigh about 1000-1600 pounds (455-727 kg.), a considerable portion of which is the weight of the fluidizable material. Because of the specialized nature of fluidizable beds, they are frequently rented, rather than owned, and must therefore be frequently transported from one site to another. Even if a bed is owned, for example by a health care facility, it may need to be regularly transported from room to room. The weight is obviously a disadvantage in a frequently transported product. In addition, fluidizable beds may be used in a home care setting where the building structure may not be designed to support such heavy weight. Moreover, the fluidizable material must be periodically cleaned, usually at a site remote from the bed. The large volume and weight of the fluidizable material contributes to the cost, time and effort required to carry out the cleansing. The above drawbacks are amplified in fluidizable beds designed for heavier occupants, including bariatric occupants. Some fluidizable beds may also be unable to maintain a satisfactorily fluidizable state when occupied by an occupant weighing more than about 300 pounds (136 kg.).

The weight of a fluidizable bed can be reduced by reducing the quantity of fluidizable material in the containment vessel. However doing so increases the risk that the quasi-fluid will fail to adequately support the occupant, especially a heavier occupant. An inadequately supported occupant will “bottom out” on the diffuser partition, i.e. only part of the occupant's weight will be supported by the fluidized material, with the remainder of the weight supported by the diffuser partition. Because the diffuser partition is typically rigid, receiving partial support from the partition is contrary to the needs of the class of patients who most need the fluidized support.

Accordingly, it is desired to limit the weight of fluidizable beds without significantly compromising fluidized support for occupants.

### SUMMARY

According to one variant of the subject matter described herein, a fluidizable bed includes a fluidizable material contained within a containment vessel and a filter sheet connected to the vessel so that a vent region of the filter sheet covers a top portion of the vessel. At least the vent region of the filter sheet has a low permeability.

The foregoing and other features of the fluidizable bed described herein will become more apparent from the following detailed description and the accompanying drawings.

### BRIEF DESCRIPTION OF THE DRAWINGS

FIG. 1 is a schematic end view of a fluidizable bed in a rest or non-fluidized state.

FIG. 2 is a view similar to that of FIG. 1 showing the bed in a powered or fluidized state.

FIG. 3 is a graphical depiction of the operating characteristics of a fluidizable bed.

FIG. 4 is a view similar to that of FIG. 1 showing the bed in a powered or fluidized state and operating in a load sharing regime.

FIG. 5 is a graphical depiction of load bearing characteristics of a fluidizable bed having a filter sheet capable of bearing part of an occupant's weight.

### DETAILED DESCRIPTION

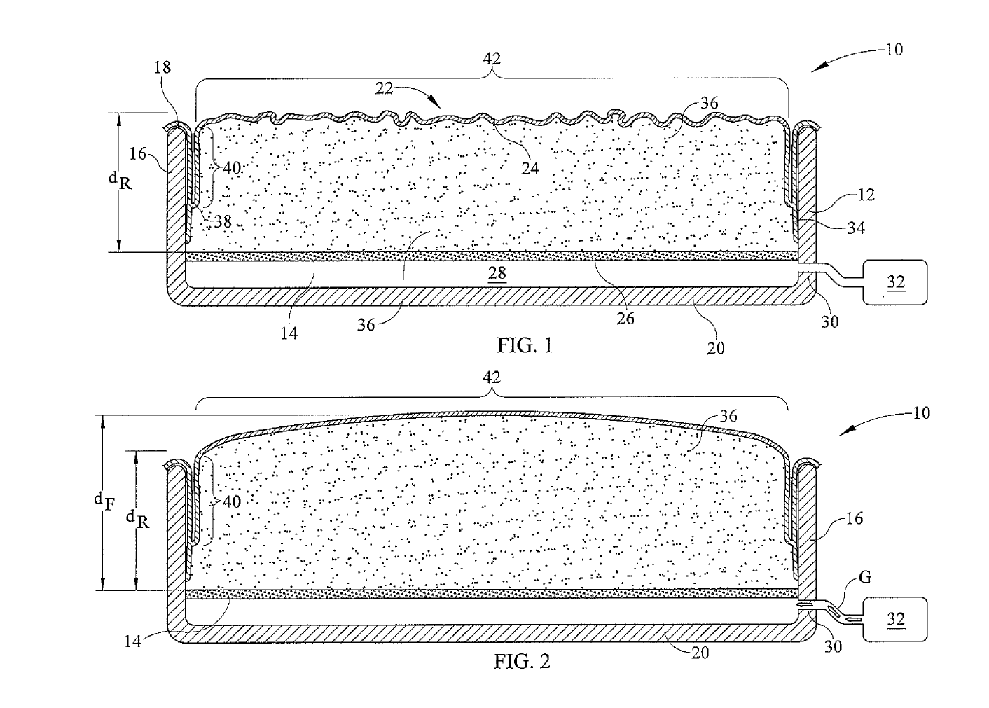

FIG. 1 shows a fluidizable bed 10 in a rest or non-fluidized state. The bed includes a containment vessel 12 having a bottom 14 and a gas impermeable perimeter wall 16 extending upwardly from the vessel bottom to a wall rim 18 and downwardly from the vessel bottom to a base 20. The wall 16 may be in the form of an air bladder. The top 22 of the vessel is open except for the presence of a filter sheet 24 described more completely below. A porous diffuser partition 26, often called a diffuser board or simply a diffuser, cooperates with vessel wall 16 and base 20 to define a gas distribution chamber 28. A gas inlet 30 penetrates wall 16. The bed also includes a blower 32, which is not operating when the bed is in its rest state. A quantity of a fluidizable material 36, such as silicon dioxide beads having a diameter on the order of about 0.001 inches (0.0254 centimeters), occupies at least part of the volume of the containment vessel and may fill the vessel to a level slightly higher than the rim 18 as depicted in the illustration. The fluidizable material has a nominal rest depth d_{R}. The diffuser partition 26, although gas permeable, resists passage of the fluidizable material therethrough.

The bed also includes a liner 34 secured to the containment vessel. A snap fit seam 38 joins the filter sheet 24 to the liner. The seam is tight enough to resist migration of the beads past the seam. Ideally the seam is also fluid-tight. The filter sheet includes a substantially impermeable containment region 40 extending along the perimeter wall 16, and also has a permeable vent region 42 overlying the top of the vessel. When the blower is not operating, at least the vent region of the filter sheet is in a slack or relaxed state. The vent region is constructed so that, despite its permeability, the beads cannot escape through the filter sheet. The term “permeability”, as quantified herein, means permeability according to ASTM (American Society for the Testing of Materials) Standard D-737-04.

FIG. 2 shows the bed in a powered or fluidized state. In the fluidized state the blower is operating and pressurizes a gaseous fluid G, usually ambient air, causing the air to enter the distribution chamber by way of the gas inlet 30. The air then flows through the diffuser partition and the beads 36 and exhausts through the vent region 42 of the filter sheet. The velocity of the air flowing through the fluidizable material causes fluidization of the material so that the fluidized medium (i.e. the air and the material 36, taken together) acts as a quasi-fluid exhibiting fluid-like properties. The fluidized material has a fluidized depth d_{F} which slightly exceeds its rest depth d_{R}.

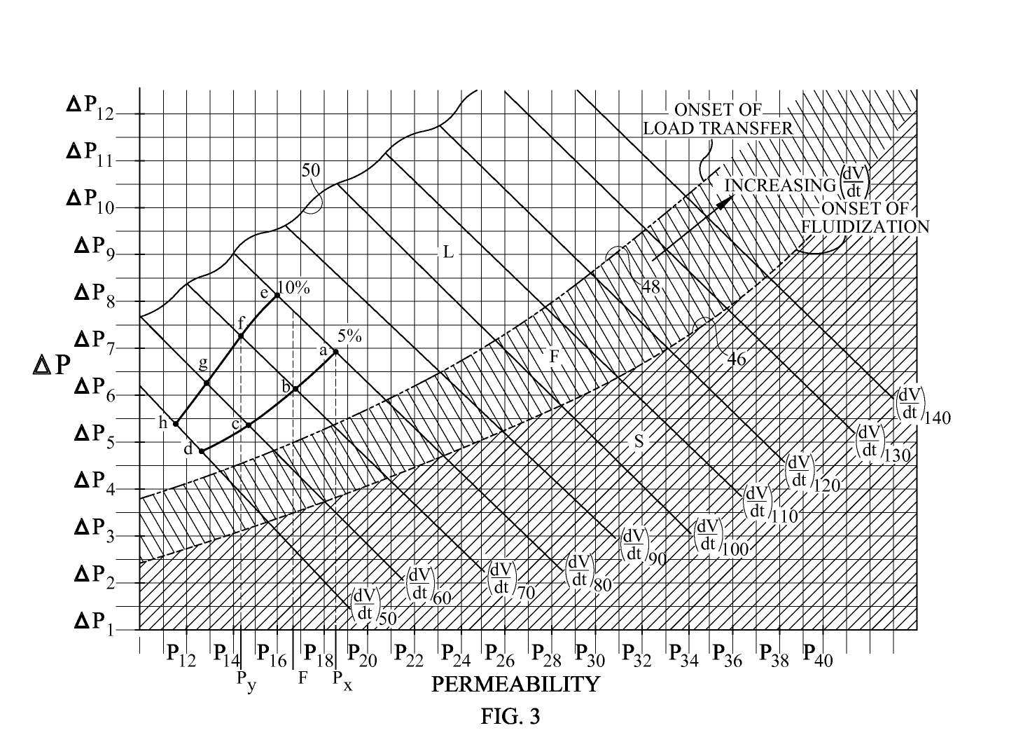

FIG. 3 reveals relevant operating characteristics of the bed illustrated in FIGS. 1 and 2. FIG. 3 shows the pressure difference or pressure drop Δp across the vent region of the filter sheet as a function of vent region permeability and volume flow rate (dV/dt) (the product of fluid velocity and flow area) of gas flowing through the fluidizable material. The parameter subscripts on the graph have no physical significance. They are merely arbitrary subscripts to aid the reader in reading the graph. The graph shows a subfluidized regime S, a fluidized support regime F and a load sharing regime L. In the subfluidized regime S, the velocity of the fluid through the fluidizable material and the vent region of the filter sheet is too low to cause fluidization of the material 36. Instead, the material remains in a non-fluidized state in which it does not take on fluid-like properties. In the fluidized support regime F, the air velocity is high enough to fluidize the fluidizable material, at least the vent region of the filter sheet remains slack, and the fluidized material supports substantially all of the occupant's weight. In the load sharing regime L, the fluidizable material is fluidized, but the vent region of the filter sheet is taut so that tension in the filter sheet supports some of the occupant's weight while the fluidized material supports the rest of the occupant's weight. A fluidization threshold 46 is the locus of operating conditions corresponding to the onset of fluidization and defining the boundary between the sub-fluidized regime S and the fluidized support regime F. A load transfer threshold 48 is a locus of operating conditions corresponding to the onset of load transfer (i.e. occupant weight transfer) from the quasi-fluid to the filter sheet. The load transfer threshold 48 defines the boundary between the fluidized support regime F and the load sharing regime L.

If the fluid velocity through the fluidizable material is too great, the material may exhibit undesirable behaviors that render the fluidization suboptimal or ineffective. One such undesirable behavior is “aggregation”, a condition in which the air rises through the beads in a series of localized jets rather than spreading out. Another type of undesirable behavior occurs when fluid velocity is high enough to lift the filter sheet and the bed occupant away from the beads. Thus, effective fluidization corresponds to a sub-zone of operating conditions whose lower bound is the fluidization threshold 46 and whose upper bound is a boundary 50 higher than the load transfer threshold 48. Effective load sharing fluidization corresponds to a sub-zone of operating conditions whose lower bound is the load transfer threshold 48 and whose upper bound is boundary 50.

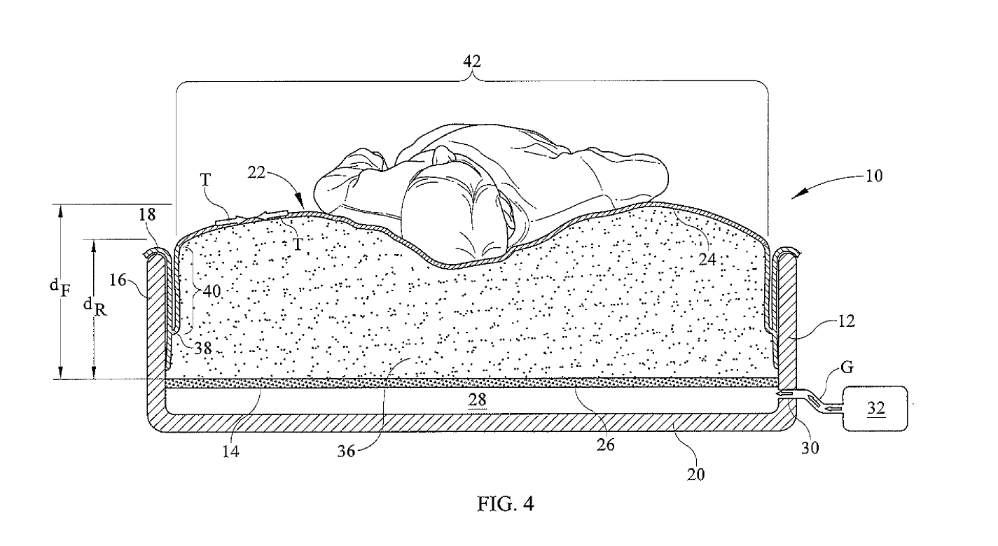

As already noted, it is desirable to reduce the weight of fluidizable beds in comparison to the expected weight of a bed occupant, and to do so in a way that the occupant will not “bottom out” on the diffuser partition. In accordance with this objective, there is an upper limit on the permeability of the filter sheet so that its permeability is less than that of conventional filter sheets used on fluidizable beds. The restricted permeability increases the resistance to airflow through the vent region of the filter sheet and increases the pressure drop Δp across the vent region. If the permeability is low enough for a given volume flow rate, the filter sheet assumes a taut or tensioned state indicated schematically by tension vectors T in FIG. 4. As a result, the filter sheet bears more than an insubstantial fraction of the occupant's weight. That is, the filter sheet bears a part of the occupant's weight that otherwise would have been borne by the fluidized medium. Consequently the depth of the beads (e.g. the rest depth d_{R}) can be reduced without risk that the occupant will bottom out on the diffuser partition. By contrast, conventional fluidizable beds feature a high permeability filter sheet. The conventional, high permeability filter sheet offers relatively little resistance to the flow of air and therefore remains in a slack or relaxed state during fluidized operation. Consequently, the filter sheet supports, at most, only a negligible portion of the occupant's weight while the fluidized material supports substantially all of the occupant's weight. Therefore the depth of the beads is greater and the weight of the bed is heavier than if applicants' less permeable filter sheet were to be employed.

For one variant of the fluidizable bed applicants have concluded that the desired combination of weight savings, “bottom out” resistance and reasonable blower size may be achieved with a filter sheet whose permeability is less than about 65 cubic feet per minute per square foot (19.8 cubic meters per minute per square meter).

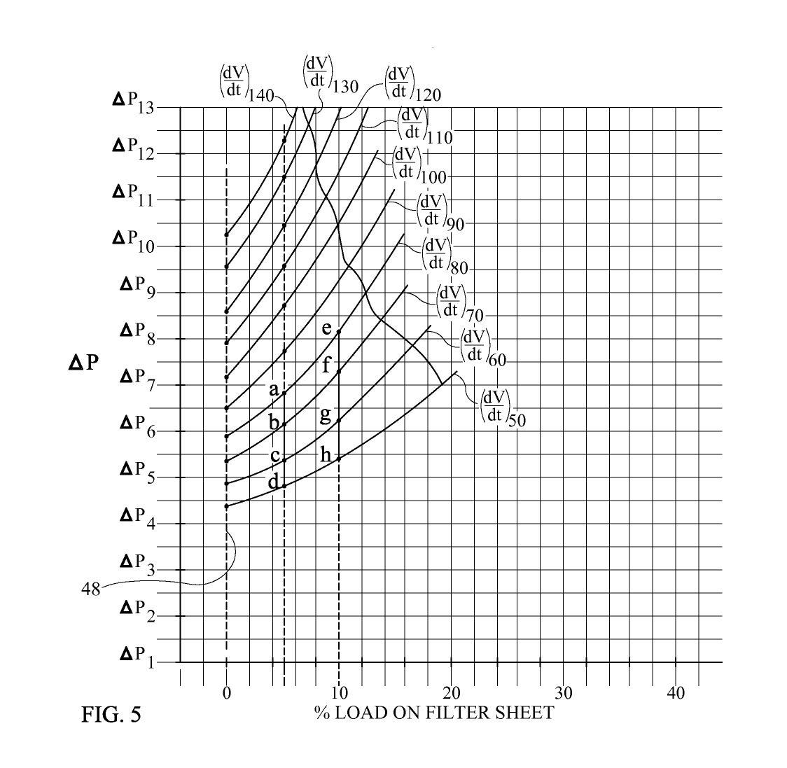

In accordance with the foregoing, at least the vent region of the filter sheet has a permeability sufficiently low to result in a pressure difference across the filter sheet equal to or greater than a prescribed pressure difference threshold. The prescribed pressure difference threshold is the load transfer threshold 48. Increasing the pressure drop beyond the load transfer threshold causes a progressive transfer of the occupant's weight from the fluidized medium to the filter sheet as seen in the graph of FIG. 5. As a practical matter the pressure difference is also within the sub-zone of effective load sharing fluidization (at least as great as the load transfer threshold, but not so high as to provoke undesirable behavior such as aggregation).

The permeability of the filter sheet vent region is sufficient to cause the filter sheet to support no more than a specified, non-zero, non-negligible portion of an occupant's weight. The proper degree of load sharing between the fluidized medium and the filter sheet will depend on the actual condition of the bed occupant (e.g. the severity of existing skin disorders) and/or the occupant's risk of developing skin disorders. Applicants have concluded that a split of 60% loading on the filter sheet and 40% loading on the fluidized material will yield an appreciable reduction in the quantity of fluidizable material and therefore an appreciable reduction in the weight of the bed. However given that the bed occupant is, by definition, suffering from a skin disorder or at risk of developing a skin disorder, a load split of 20% on the filter sheet and 80% on the fluidized material may be more appropriate and would nevertheless yield a noteworthy reduction in the volume of beads and weight of the bed. Alternatively it may be desirable to express the loading on the filter sheet as an absolute weight, for example a 20 pound (9 kg) load on the filter sheet, or as a percentage of occupant weight, for example a 2% proportion of weight on the filter sheet.

The force per unit area required to support a given weight can be determined by the method outlined in the following example. The method recognizes that the pressure difference Δp across the filter sheet represents a force per unit area available to support an occupant's weight or required to support a given weight (and therefore can be used to determine the required permeability of the filter sheet). First, determine occupant contact area as a function of patient weight. Occupant contact area is the area of an occupant's body in contact with the vent region of the filter sheet and therefore is a part of the vent region through which air cannot flow. The determination can be made, for example, experimentally or analytically. Second, determine the operable permeable area of the vent region by taking the difference between the total area of the vent region and the occupant contact area. Third, divide occupant weight by the operable permeable area to determine the weight per unit area, i.e. the pressure drop Δp, necessary for the filter sheet to support the entire occupant weight. Fourth, multiply the calculated pressure drop by the fraction of occupant weight desired to be supported by the filter sheet to determine the pressure drop required to support the desired weight fraction. The following table shows two sample calculations, one for a 150 pound (68 kg.) occupant and one for a 350 pound (159 kg.) occupant.

| | | |
|---|---|---|
| Weight (pounds) | 150 | 350 |
| Occupant Contact | 400 | 700 |
| Area (square inches) | | |
| Vent Region Area | 2000 | 2000 |
| (square inches) | | |
| Operable Permeable | 1600 | 1300 |
| Area (Square inches) | | |
| Weight/Unit Area | 150/1600 = .094 | 350/1300 = .269 |
| (i.e. Δp))pounds | | |
| per square inch) | | |
| Weight Fraction to | 0.20 | 0.20 |
| be Supported by | | |
| Filter Sheet | | |
| Δp to support | .0188 | .0538 |
| desired weight | | |
| fraction (pounds | | |
| per square inch) | | |

With the required Δp having been determined, it is a straightforward matter to select an appropriate permeability. For example, referring to FIGS. 3 and 5, if it is desired to have a load split of 5% on the filter sheet and 95% on the fluidized medium (the locus defined by points a, b, c and d on the figures) and if the blower were capable of delivering a volume flow rate of no more than (dV/dt)₈₀, a permeability of less than Pₓ would be selected.

The blower must have the capacity to propel air through the fluidizable material and exhaust the air through the filter sheet at a flow rate and velocity sufficient to establish a pressure difference across the vent region of the filter sheet that equals or exceeds a prescribed pressure difference threshold. As a practical matter, the prescribed pressure difference threshold will be at least the load transfer threshold 48 of FIG. 3. The operating characteristics of FIGS. 3 and 5 can also be used to select a blower capacity as a function of a given permeability and a requirement to support a given load or to achieve a desired load split. For example if it is desired to achieve a load split of 10% on the filter sheet and 90% on the fluidized medium (the locus defined by points e, f, g, h in the figures) and if the filter sheet permeability were P_{y}, the required blower flow capacity would be (dV/dt)₇₀.

Similar calculations may be carried out if the load to be supported by the filter sheet is expressed as an absolute non-negligible weight, (for example 20 pounds) or as a non-negligible percentage of a weight (for example 2%) rather than as a desired degree of load sharing between the filter sheet and fluidized material. A prescribed weight of 20 pounds or a prescribed percentage weight of 2% will enable the removal of at least some of the fluidizable material while still allowing fluidized support of a large portion of an occupant's weight and the attendant reduced risk of skin disorders.

Although high weight may be a shortcoming of fluidizable beds designed for an average occupant, the weight of a fluidizable bed designed for a heavier occupant, including a bariatric occupant, may be prohibitive. By employing the load sharing concepts described herein, the population able to benefit from the advantages of fluidizable beds may be extended to heavier occupants, for example occupants weighing more than about 350 pounds (159 kg.) Moreover, it may be possible to achieve a weight of the bed itself of less than about 950 pounds (432 kg.). And although a larger, heavier bed may be needed to accommodate heavier occupants, the concepts described herein may nevertheless make it possible to construct a fluidizable bed capable of maintaining a satisfactorily fluidized state when occupied by a an occupant weighing at least 300 pounds (136 kg.) and/or weighing no more than about four times the weight of the intended occupant even if the occupant weighs 350 pounds (159 kg.) or more.

The use of the low permeability filter sheet described herein is not limited to newly manufactured beds, but may also be applied to existing fluidizable beds. Accordingly, a kit for retrofitting existing beds includes a filter sheet having a low permeability vent region. Applicants have concluded that a permeability of less than about 65 cubic feet per minute per square foot (19.8 cubic meters per minute per square meter) would be appropriate. The kit may also include instructions guiding a bed owner or a technician on the procedure for replacing an existing higher permeability filter sheet with the retrofit, lower permeability filter sheet and also advising of the volume or weight of fluidizable material that may be removed from the bed as a result of using the lower permeability sheet. Alternatively the kit may include only the vent region of the filter sheet rather than the entire filter sheet, in which case any instructions would advise how to replace the vent region of the existing filter sheet with the retrofit vent region. A retrofit kit may also include a blower having a flow capacity higher than that of the non-retrofit blower of a fluidizable bed to be retrofit.

Although this disclosure describes specific embodiments, those skilled in the art will appreciate that various changes in form and detail may be made without departing from the subject matter set forth in the accompanying claims.

We claim:

1. A fluidizable bed comprising:
a fluidizable material within a containment vessel having a gas inlet;
a filter sheet having a vent region covering a top portion of the vessel;
at least the vent region of the filter sheet having a permeability of less than about 65 cubic feet per minute per square foot (19.8 cubic meters per minute per square meter).

2. The fluidizable bed of claim 1 comprising a blower capable of propelling air through the material and exhausting the air through the filter sheet at a flow rate sufficient to establish a pressure drop across the filter sheet equal to or greater than a load transfer threshold.

3. A fluidizable bed comprising:
a fluidizable material within a containment vessel having a gas inlet;
a filter sheet having a vent region covering a top portion of the vessel;
at least the vent region of the filter sheet having a permeability and a flow rate therethrough sufficient to establish a pressure difference across the filter sheet equal to or greater than a prescribed pressure difference threshold.

4. The fluidizable bed of claim 3 wherein the pressure difference threshold corresponds to a load transfer threshold.

5. The fluidizable bed of claim 3 wherein the established pressure difference corresponds to effective load sharing fluidization of the material.

6. The fluidizable bed of claim 5 wherein the established pressure difference has an upper bound corresponding to “aggregation”.

7. The fluidizable bed of claim 3 wherein the established pressure difference corresponds to a prescribed load sharing between the filter sheet and the fluidizable material when the material is fluidized.

8. The fluidizable bed of claim 7 wherein the prescribed load sharing is in the range of 20% to 60% occupant loading on the filter sheet and 80% to 40% occupant loading on the medium.

9. A fluidizable bed comprising:
a fluidizable material within a containment vessel having a gas inlet;
a filter sheet having a vent region covering a top portion of the vessel;
at least the vent region of the filter sheet having a permeability and flow rate therethrough sufficient to cause the filter sheet to support no more than a specified, non-negligible weight.

10. The bed of claim 9 wherein the specified, non-negligible weight is about 20 pounds (9 kilograms).

11. The bed of claim 9 wherein the specified, non-negligible weight is about 2% of an occupant's weight.

12. The fluidizable bed of claim 1 having an occupant capacity of at least about 350 pounds (159 kilograms).

13. The fluidizable bed of claim 1 having a weight no greater than about four times the weight of an occupant of the bed weighing at least about 350 pounds (159 kilograms).

14. The fluidizable bed of claim 1 capable of maintaining the material in a fluidized state while supporting an occupant weighing at least 300 pounds (136 kilograms).

15. The fluidizable bed of claim 1 having a weight of less than about 950 pounds (432 kilograms).

16. The fluidizable bed of claim 9 having an occupant capacity of at least about 350 pounds (159 kilograms).

17. The fluidizable bed of claim 9 having a weight no greater than about four times the weight of an occupant of the bed weighing at least about 350 pounds (159 kilograms).

18. The fluidizable bed of claim 9 capable of maintaining the material in a fluidized state while supporting an occupant weighing at least 300 pounds (136 kilograms).

19. The fluidizable bed of claim 9 having a weight of no more than about 950 pounds (432 kilograms).

20. A bariatric patient support system, comprising:
a vessel capable of supporting an occupant weighing more than about 350 pounds (159 kilograms), the vessel having a base, a perimeter wall extending upwardly from the base, and an open top;
a gas permeable diffuser residing above the vessel base and cooperating with the base and perimeter wall to define a chamber;
a quantity of a fluidizable material supported by the diffuser, the diffuser being resistant to passage of the fluidizable material therethrough; and
a filter sheet covering the vessel top, the filter sheet having a gas permeable vent region overlying the vessel top, the filter sheet being otherwise substantially gas impermeable.

21. A bariatric patient support system, comprising:
a vessel capable of supporting an occupant having a weight, the vessel having a base, a perimeter wall extending upwardly from the base, and an open top;
a diffuser residing above the base and cooperating with the base and perimeter wall to define a chamber;
a quantity of a fluidizable material supported by the diffuser, the diffuser being resistant to passage of the a filter sheet covering the vessel top, the filter sheet having a gas permeable vent region overlying the vessel top, the filter sheet being otherwise substantially gas impermeable;
the patient support system weighing no more than about four times the weight of an occupant weighing at least 350 pounds (159 kilograms).

22. A bariatric patient support system, comprising:
a vessel having a base, a perimeter wall extending upwardly from the base, and an open top;
a diffuser residing above the base and cooperating with the base and the perimeter wall to define chamber, the diffuser being permeable to passage of gas therethrough,
a quantity of fluidizable material supported by the diffuser, the diffuser being resistant to passage of fluidizable material therethrough, and
a gas permeable sheet covering the vessel top, the sheet being joined to the vessel wall at a joint resistant to migration of the fluidizable material therethrough;
at least one of the vessel, the diffuser, the quantity of the fluidizable media, and the gas permeable sheet being adapted to maintain the quantity of fluidizable media in a fluidized state while supporting an occupant in weighing more than about 300 pounds (136 kilograms).

23. A bariatric patient support system, comprising:
a vessel having a base, a perimeter wall extending upwardly from the base, and an open top;
a diffuser residing above the vessel base and cooperating with the base and the perimeter wall to define chamber, the diffuser being permeable to passage of gas therethrough,
a quantity of fluidizable material supported by the diffuser, the diffuser being resistant to passage of fluidizable material therethrough, and
a gas permeable sheet covering the vessel top, the sheet being joined to the vessel wall at a joint resistant to migration of the fluidizable material therethrough;
the patient support system weighing no more than about 950 pounds.

24. A retrofit kit for a fluidizable bed comprising at least one of:
a) a filter sheet having a permeability of less than that of a non-retrofit filter sheet of a fluidizable bed to be retrofit;
b) a filter sheet vent region having a permeability less than that of a non-retrofit filter sheet vent region of a fluidizable bed to be retrofit; and
c) a blower having a capacity higher than that of a non-retrofit blower of a fluidizable bed to be retrofit.

25. The retrofit kit of claim 24 wherein the filter sheet has a permeability of less than about 65 cubic feet per minute per square foot (19.1 cubic meters per minute per square meter) and the filter sheet vent region has permeability of less than about 65 cubic feet per minute per square foot (19.8 cubic meters per minute per square meter).

26. A fluidizable bed comprising:
a fluidizable material contained within a containment vessel, the vessel having a gas inlet;
a filter sheet connected to the vessel so that a vent region of the filter sheet covers a top portion of the vessel;
the bed having a non-fluidized state in which at least the vent region of the filter sheet is in a relaxed state and a fluidized state in which at least the vent region of the filter sheet is in a taut state.

27. The bed of claim 26 wherein the taut state is taut enough for the filter sheet to carry more than an insubstantial fraction of the weight of an occupant of the bed.
